(19) United States
(12) Patent Application Publication
(10) Pub. No.: US 2005/0264652 A1
(43) Pub. Date: Dec. 1, 2005

(54) Computer camera field of vision automatic switching device

(76) Inventor: Hui-hu Liang, Siu Shui Hsiang (TW)

Correspondence Address: TROXELL LAW OFFICE PLLC, Suite 1404, 5205 LEESBURG PIKE, FALLS CHURCH, VA, 22041, US

(21) Appl. No.: 10/855,843

(22) Filed: May 28, 2004

(51) Int. Cl. H04N 5/228

(52) U.S. Cl. 348/208.2

(57) ABSTRACT

A computer camera field of vision automatic switching device consisting of a computer monitor equipped with a camera that has a minimum of one roller ball switch installed in it, the signal output pin of which is connected to the input terminal of an image processor integrated circuit for capturing the control signal based on the position of the roller ball in the roller ball switch. After the image processor integrated circuit receives the changed signal normal status, the signal is transferred via the universal serial bus to a personal computer, where an image processing program determines the control signal value and verifies that the computer camera is at the rotated angle, the image processing program controlling image rotation based the determined angle of the computer camera lens and the quantity of roller ball switches. As such, whatever the interval of rotation, 90 degrees or 180 degrees, the field of vision is always displayed on the monitor in the current straight ahead position, without requiring the manual selection of numerous vertical or horizontal rotation command items, thereby achieving automatic field of vision switching and providing user convenience.

### BACKGROUND OF THE INVENTION

1) Field of the Invention

The invention herein relates to a computer camera that captures field of vision images and utilizes roller ball switch signal normal status; the said signal is received by an image processor integrated circuit which is then transferred to a personal computer, where a program determines the signal value and verifies the computer camera angle of rotation (such as left and right 90 degrees and 180 degrees around) to control the field of vision image such that it is rotated the said same angle, enabling the image on the monitor to always be displayed in the straight-ahead position, thereby providing for the automatic switching of images without requiring manual command item selection by the user.

2) Description of the Prior Art

Most conventional computer cameras are typically installed on the edges of computer monitors to provide for displaying captured images on the computer screen, with the angle and location of the computer camera determined according to the peripheral environment and individual requirements. Naturally, if the postured angle of the computer camera is the straight-ahead direction, then the image appearing on the monitor is also that of the straight-ahead direction, and thus if the said computer camera is situated at an angle straight ahead of 90 degrees or 180 degrees, then the field of view image on the monitor is correspondingly turned 90 degrees or 180 degrees, and the user must select a vertical or horizontal rotation command item through an image processing program to control the rotation of said field of vision image to the current straight-ahead position.

### SUMMARY OF THE INVENTION

I. Problems Requiring Solution

Since the location at which said computer camera is postured differs according to user requirements and, furthermore, the postured angle of the said computer camera and the scope of image capture changes, if the computer camera is situated at a straight disposition 90 degrees to left and right horizontally or turned around 180 degrees, then the image displayed on the monitor is rotated a corresponding number of degrees such that the user must manually select on-screen command items to vertically or horizontally rotate the said image, resulting in user operating difficulty and inconvenience.

II. Means of Solution

1. The first embodiment of the invention herein consists of a roller ball switch installed in a computer camera and, furthermore, the said roller ball switch and the camera lens direction are in a straight, horizontal arrangement (also referred to as straight ahead), with the roller ball of the roller ball switch situated at the bottom extremity, constituting a signal normal status internally set at the signal input terminal of an image processor integrated circuit signal such that after the image processor integrated circuit receives the said control signal, it is transferred via universal serial bus to the personal computer, where a program determines the value of the said control signal and verifies that the computer camera is in the straight-ahead position, thereby controlling the field of vision image at the straight-ahead position; when the computer camera is rotated 180 degrees, the roller ball in the said roller ball switch contacts the image processor integrated circuit signal output pin, changing the internally set signal normal status and automatically switching the image to the current straight-ahead position based to the said control, thereby providing for automatic image rotation to the straight-ahead position on the monitor without requiring user image command item selection.

2. The second embodiment of the invention herein is based on expanding the principles of the said first embodiment, wherein two said roller ball switches are situated in the computer camera for the straight-ahead position and, furthermore, at a suitable angle apart; when the computer camera is in the straight-ahead position, the roller balls in the said two roller ball switches both descend to the top section in the roller ball switches, constituting the set signal normal status of the image processor integrated circuit, the straight-ahead image of which is displayed on the monitor; when the computer camera is rotated 90 degrees, since the roller ball switches are at a certain angle apart, the roller balls in the two roller ball switches each roll in different directions to the respective top and bottom sections of the dissimilarly inclined roller ball switches and one of the roller balls contacts a roller ball switch signal output pin, changing the signal normal status the image processor integrated circuit such that after the image processor integrated circuit receives the said control signal, it is transferred via universal serial bus to the personal computer, where a program determines the value of the said control signal and verifies that the computer camera is in the 90-degree rotated position, thereby controlling the field of vision image to the straight-ahead position on the monitor; when the computer monitor is at the 180-degree rotated position, then both of the roller balls in the said roller ball switches descend to the bottom sections postured at the said angle apart and, utilizing the said same principles, thereby control the image to the current straight-ahead position on the monitor.

### BRIEF DESCRIPTION OF THE DRAWINGS

FIG. 1 is the block diagram of the first embodiment of the invention herein.

FIG. 1-A is an orthographic drawing of the computer camera invention herein in the straight position.

FIG. 1-B is an isometric drawing of the computer camera invention herein in the straight-ahead, 180-degree position.

FIG. 2 is a flowchart of the first embodiment of the invention herein.

FIG. 3 is a block diagrams of the second embodiment of the invention herein.

FIG. 3-A to 3-H are orthographic and isometric drawings of the computer camera invention herein oriented at various angles.

FIG. 4 is a flowchart of the second embodiment of the invention herein.

### DETAILED DESCRIPTION OF THE INVENTION

The embodiments of the computer camera field of vision automatic switching device of the invention herein are provided below solely for purposes of elaboration.

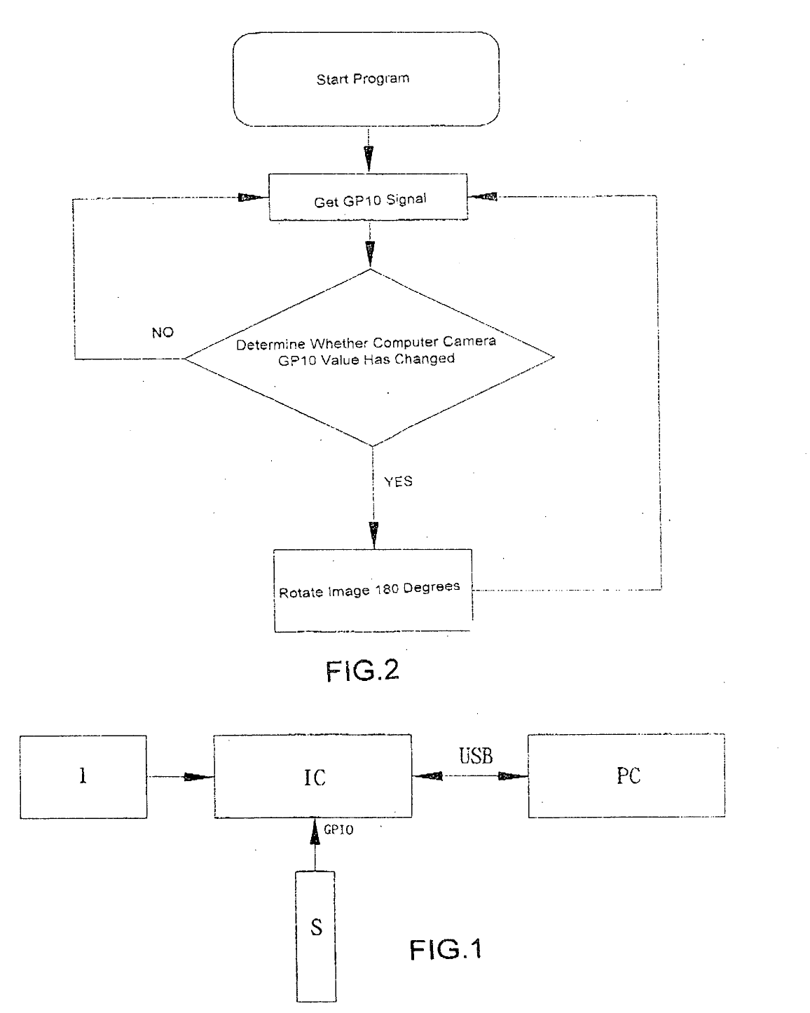

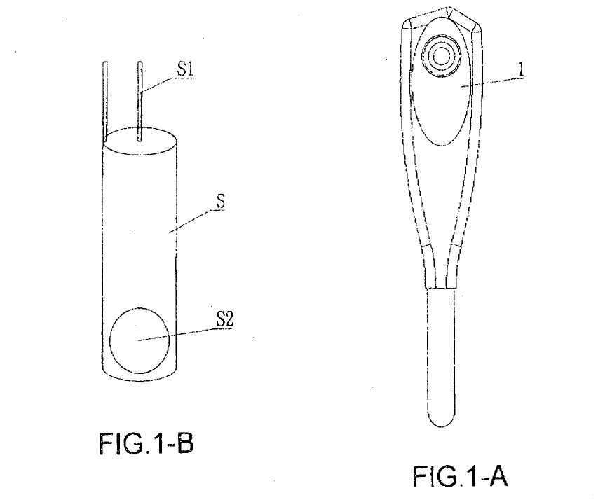

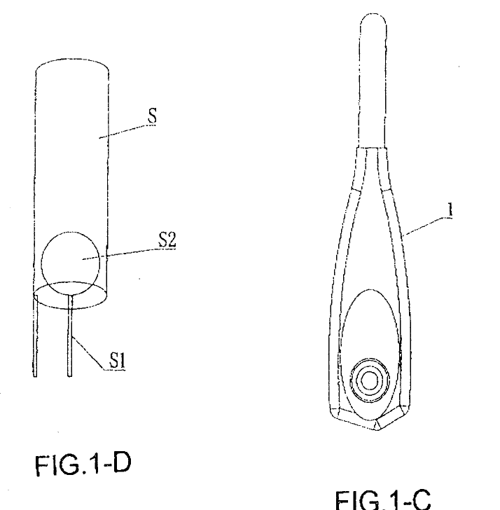

Referring to FIG. 1, the induced signal of the said computer camera 1 is connected to an image processor integrated circuit (IC) and via the universal serial bus (USE) connected to the personal computer (PC), wherein the control pin GP10 of the image processor IC is connected to the signal output pin S1 of a roller ball switch S; referring to FIG. 1-A, FIG. 1-B, and FIG. 2, when the computer camera 1 is postured in the straight ahead position, the roller ball switch S roller ball S2 descends to the bottom section of the roller ball switch S and does not contact the signal output pin S1, such that the internally set signal normal status of the image processor IC control pin GP10 is unchanged, enabling the field of vision image signal through the image processor IC to remain at the internally set signal normal status, the PC program controlling the said image and displaying the straight-ahead position on the monitor; referring to FIG. 1-C and FIG. 1-D, when the computer camera 1 is panned to the straight-ahead, 180-degree position, the roller ball switch S signal output pin S1 is tilted vertically downward, causing the roller ball 2 to contact the said signal output pin S1, changing the signal normal status of the image processor TC control pin GP10, the image processor IC outputted control signal is transferred via the USB to the PC, where program control automatically rotates the image 180 degrees such that whether the field of vision image is at a straight-ahead or a 180-degree position, the said field of vision image is determined by the position of the roller ball switch S, which controls automatic rotation to the current straight-ahead position, thereby achieving utilization convenience.

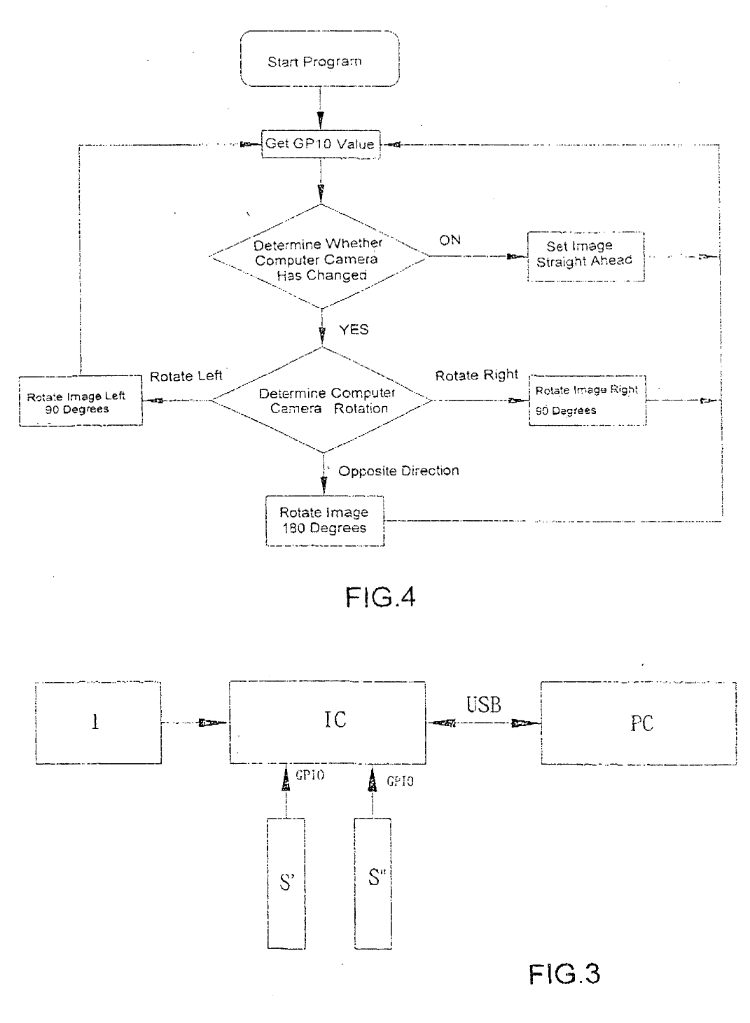

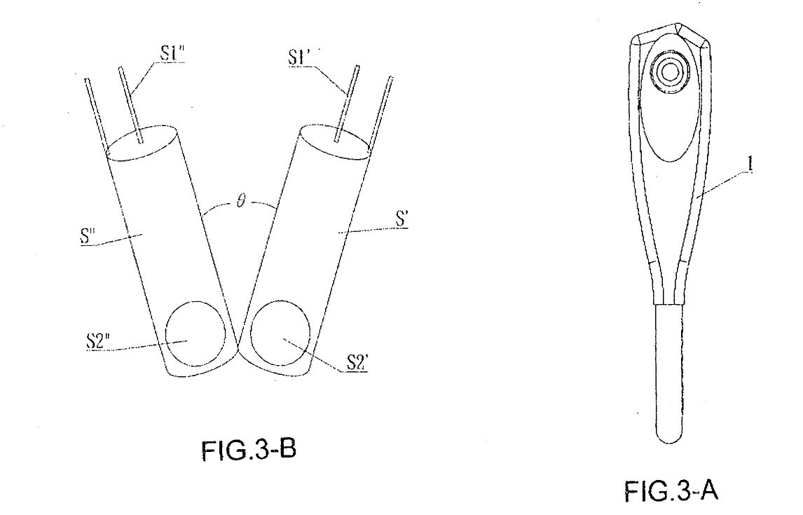

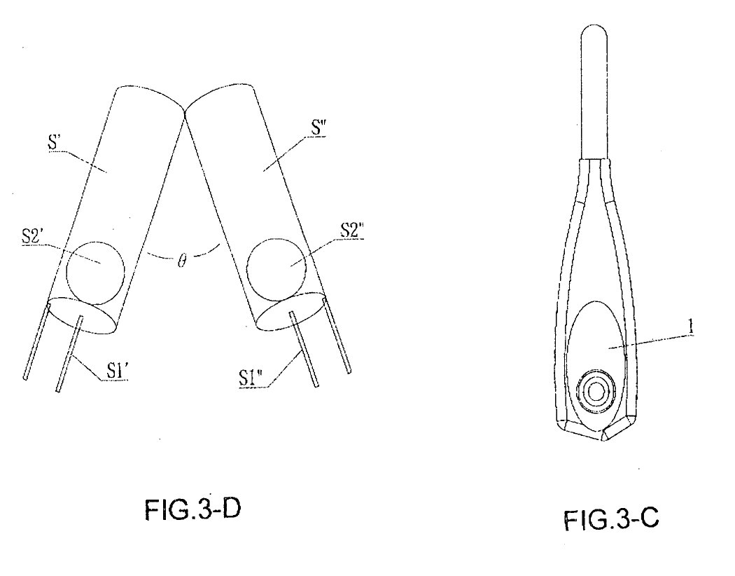

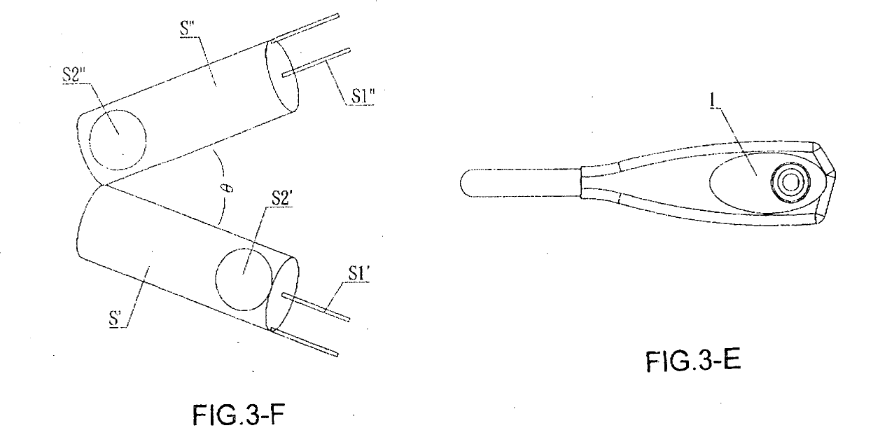

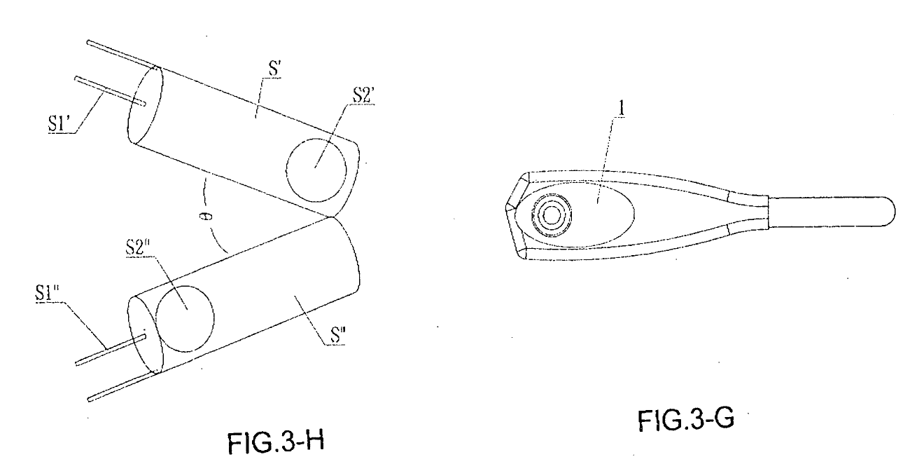

The said roller ball switch S utilized to rotate the computer camera 1 between the straight-ahead and the 180-degree position and automatically controlling the image to the current straight-ahead position is expandable such that the image is controlled to automatically rotate and be displaced on the monitor at the current straight-head position when the computer camera 1 of the invention herein is at the straight-ahead, 90 degrees to the right, 90 degrees in the opposite direction, and 180 degrees turned around positions; referrring to FIG. 3 and FIG. 4, two roller ball switches S′ and S″ are installed in the computer camera 1, and the said two roller ball switches S′ and S″ are situated at the computer camera 1 straight-ahead position and, furthermore, at a suitable directional orientation apart of θ degrees (as shown in FIG. 3-A and FIG. 3-B); when the computer camera 1 is at the straight-ahead position, the roller bails S2′ and S2″ inside the two roller ball switches S′ and S″ both, descend to the bottom sections in the roller ball switches S′ and S″ and do not contact the said signal output pins S1′ and S1″ such that the signal normal status of the image processor IC control pin GP10 is unchanged and the image is displayed on the monitor is that which is straight ahead: referring to FIG. 3-E, FIG. 3-F, FIG. 3-G, and FIG. 3-H, when the computer camera 1 is rotated to the right 90 degrees (as shown in FIG. 3-E) or in the opposite direction 90 degrees (as shown in FIG. 3-G), then since the said roller ball switches S′ and S″ are situated at θ degrees apart, the roller balls S2′ and S2″ inside the two roller ball switches S′ and S″ each roll in different directions to the respective bottom sections of the dissimilarly inclined roller ball switches S′ and S″, as indicated in FIG. 3-G and FIG. 3-H, when the computer camera 1 is rotated to the left for 90 degrees, then the roller ball S2′ descends to the top section of the roller ball switch S′ and the other roller ball S2″ contacts the signal output pin S1″; referring to FIG. 3-E and FIG. 3-F, the computer camera 1 is rotated 90 degrees to the right, the roller ball S2″ then descends to the top section of the roller switch S″ and the other roller ball S2′ contacts the signal output pin S1′; the said conditions change the signal normal status of the image processor IC control pin GP10, causing the image processor IC outputted signal to be transferred via the USB to the PC, where the program determines the said control signal value and verifies that the computer camera 1 is at the 90 degrees to the right or 90 degrees in the opposite direction position, thereby controlling the field of vision image rotation to the current straight-ahead position on the monitor; referring to FIG. 3-C and FIG. 3-D, when the computer camera 1 is in the 180 degrees turned around position, then the roller balls S2′ and S2″ inside the two roller ball switches S′ and S″ both descend to the bottom sections in the roller ball switches S′ and S″ which are disposed apart at the said θ degrees and, at the same time, the said two roller ball switches S′ and S″ both descend to the signal output pins S1′ and S2″ positions and, furthermore, establish contact, utilizing the said same principles for controlling the image to automatically rotate around 180 degrees to the current straight-ahead position on the monitor.

1. A computer camera field of vision automatic switching device in which the signals of a computer camera are transferred to the PC through an image processor IC via USB, enabling the display of the field of vision image on the monitor, the features of which are:
The said computer camera has a minimum of one roller ball switch installed in it and, furthermore, the signal output pin of the said roller ball switch is connected to the control pin of the said image processor IC:
The roller ball of the said roller ball switch when straight ahead is situated at the top extremity; at the rotation of the said computer camera, a minimum of one said roller ball becomes situated at the said signal output pin position and, furthermore, is in a state of contact, changing the signal normal status of the said image processor IC control pin, the PC program controlling image rotation such that it is the at same rotated angle as the said computer camera, enabling the image to be automatically rotated to the straight-ahead position on the monitor.

2. As mentioned in claim 1 of the computer camera field of vision automatic switching device of the invention herein, two said roller ball switches are installed in the said computer camera and, furthermore, at the straight-ahead position of the said computer camera, the said two roller ball switches each inclined at a suitable angle apart such that the said roller balls are both situated at the top extremities of the said roller ball switches and separated from the said signal output pin such that signal normal status at the two said control pins of the said image processor IC remain unchanged, enabling the display of the image in the straight-ahead position on the monitor.

3. As mentioned in claim 2 of the computer camera field of vision automatic switching device of the invention herein, the said computer camera causes the said two roller ball switches to rotate 90 degrees to the right or 90 degrees in the opposite direction, the said two roller ball switches inclined at a suitable angle apart such that the said roller balls respectively descend to the top extremity and the bottom extremity of the said roller ball switches and, furthermore, the said roller balls contact the said signal output pins, thereby providing for changing the signal normal status of the said image processor IC control pins and enabling the PC program to control image rotation automatically such that it is at the same rotated angle as the said computer camera.

4. As mentioned in claim 2 of the computer camera field of vision automatic switching device of the invention herein, the said computer camera causes the said two roller ball switches to turn around 180 degrees such that the each of the said two roller balls descent to the bottom extremities of the said roller ball switches and, furthermore, both contact the said signal output pins, thereby providing for changing the signal normal status at the said two control pins of the said image processor IC and enabling the PC program to control image rotation automatically such that it is at the same rotated angle as the said computer camera.
